(19) United States
(12) Patent Application Publication
(10) Pub. No.: US 2022/0151873 A1
(43) Pub. Date: May 19, 2022

(54) HOOKING AND PIERCING DEVICE FOR VIALS AND TUBES PROVIDED WITH A CLOSING CAP OPENABLE BY PRESSURE

(71) Applicant: Paolo Gobbi Frattini S.R.L., Milano (IT)

(72) Inventor: Paolo Giuseppe GOBBI FRATTINI, Sondalo SO (IT)

(73) Assignee: Paolo Gobbi Frattini S.R.L., Milano (IT)

(21) Appl. No.: 17/528,221

(22) Filed: Nov. 17, 2021

(30) Foreign Application Priority Data
Nov. 17, 2020 (IT) 202020000006378

(51) Int. Cl. A61J 1/20; B65D 51/00

(52) U.S. Cl. CPC A61J 1/2048; B65D 51/002; A61J 1/2089; A61J 1/201; A61J 1/2027

(57) ABSTRACT

A hooking and piercing device (1) for vials and tubes provided with a closing cap openable by pressure, comprising a hooking hood (2) with circumferentially distributed hooking toothed sectors (3) and an axial perforated stem (4) which extends axially and centrally out of the hooking hood (2) to be engaged by pressure inside a tube. The axial perforated stem (4) has an axially perforated appendix (6) which extends inside the hooking hood (2) and is shaped like a syringe luer. A frangible closing element (17) on the axial perforated stem (4) may be provided at the end of the axial perforated stem (4) opposite to the one with the luer-shaped appendix (6).

### BACKGROUND OF THE INVENTION

The present invention relates to a device usable for hooking the closing cap of vials and tubes provided with a hermetic closing cap openable by axial pressure.

Hooking and piercing devices are known, which are used to couple the terminal mouth of vials containing medicinal or nutritional substances from underneath and pierce the hermetic closing cap with which the vials themselves are provided at the same time.

This is particularly the case in the pharmaceutical field, in which bags containing a liquid solution must often be coupled to a vial or the like which contains an active substance in powder or gel form to be mixed with the liquid solution.

The known hooking and piercing devices usable for such a purpose usually comprise a hood-shaped hooking part with circumferentially distributed toothed hooking sectors and an axially pierced stem which extends axially and centrally out of the hooking portion to be engageable by pressure within a tube either with or without a valve connector, which extends out of the bag.

The aforesaid axially perforated stem has an axially perforated appendix which extends inside the hooking portion and has a pointed needle end, which is capable of piercing the closing cap of the vial or the like to connect the inner space of the bag with that of the vial and mix the active substance and diluent solution.

There are vial caps like the one described in EP 2 867 132 B1, which do not necessarily need to be pierced with a sharp needle, and for this reason, we thought to modify the known hooking and piercing devices so as to avoid the work, necessary to form a sharp needle.

### SUMMARY OF THE INVENTION

It is the object of the present invention to make a vial hooking device which does not provide for the presence of a sharp needle for piercing the closing cap of the vial.

According to the present invention, such an object is achieved by a device comprising a hood-shaped hooking part with circumferentially distributed hooking toothed sectors and a connecting part formed by an axially perforated stem which extends axially and centrally out of said hooking part to be engaged by pressure inside a tube, said stem having an axially perforated appendix which extends within the hooking part, characterized in that said appendix is shaped like a syringe luer.

### DESCRIPTION OF THE DRAWINGS

An embodiment of the device according to the invention and a possible variant thereof are shown by way of example in the appended drawings, wherein:

FIG. 1 shows an axial section of the device;

FIG. 2 shows a front view of the same device;

FIG. 3 shows the same device seen from the bottom relative to FIG. 2:

FIG. 4 shows the same device seen from the top relative to FIG. 2;

FIG. 5 shows a vial with a closing cap which can be opened by axial pressure, to which the device of FIGS. 1-4 can be coupled;

FIG. 6 shows the device in FIGS. 1-4 and the vial in FIG. 5 after hooking;

FIG. 7 shows a axial section of a variant of the device in FIGS. 1-4;

FIG. 8 shows a front view of the variant.

### DETAILED DESCRIPTION OF THE INVENTION

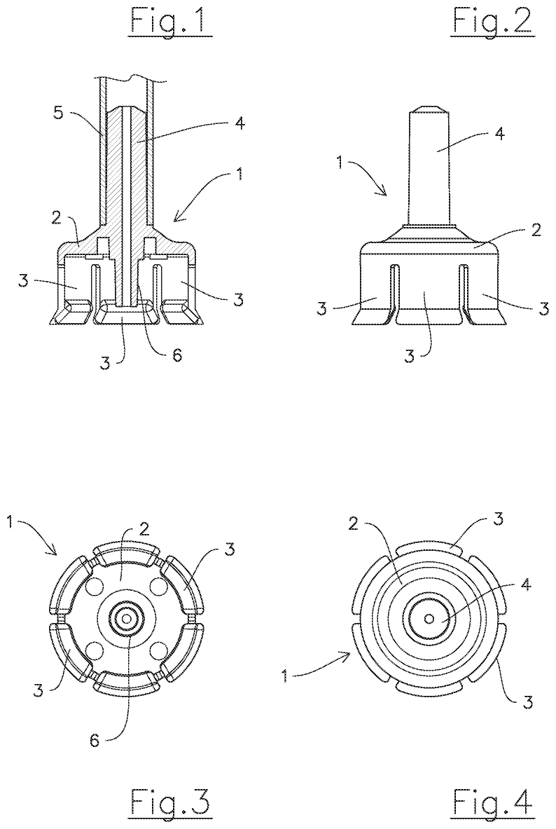

The device shown in FIGS. 1-4, indicated as a whole with the number 1, has a hooking part formed by a hood 2 with circumferentially distributed toothed sectors 3 intended to couple the cap of a vial and a connection part formed by an axially pierced stem 4 intended to be inserted by axial pressure into the end of a tube 5 connected either directly or through a connector to a bag containing a liquid solution. The stem 4 has a terminal appendix 6 shaped like a syringe luer which extends inside the hood 2.

The hood 2 with toothed sectors 3 and the luer-shaped end appendix 6 respectively couple and pierce a cap of a vial which is preferably but not necessarily of the type described in EP 2 867 132 B1.

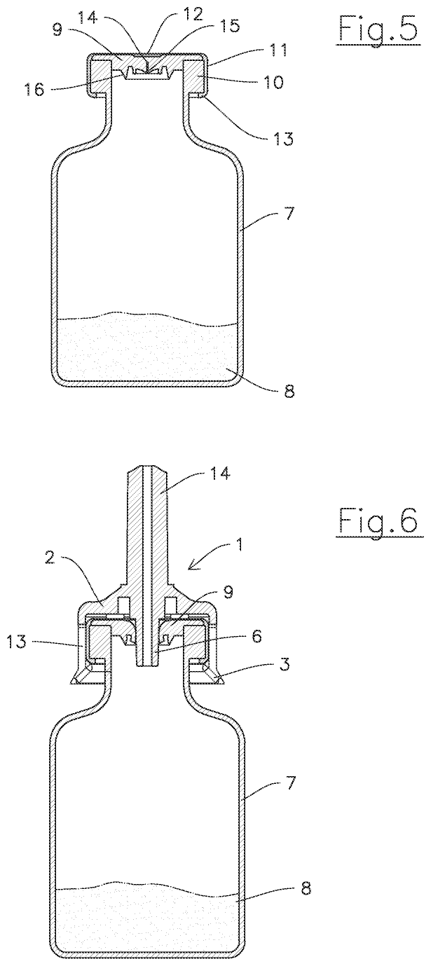

A vial 7 containing an active substance 8 in powder or gel form and provided with a hermetic closing cap 9 coupled to the thickened mouth 10 of the vial by means of a metal collar 11 with a central hole 12 and hooking flaps 13 is shown in FIG. 5. According to EP 2 867 132 B1, the cap 9 is made of elastically deformable material and has a central portion formed by a thin membrane 14 below which a thin slit 15, which ends between a pair of side lips 16, extends.

As shown in FIG. 6, by hooking the toothed sectors 3 of the cap 2 of the hooking and piercing device 1 below the mouth 10 of the vial 7, the luer-shaped appendix 6 of the same device pierces the central membrane 14 of the closing cap 9 and is inserted into the slot 15 enlarging it until ending in the inner space of the vial.

Thus, a fluid path is formed from the inner space of the vial 7 to the tube 5 and from there to the bag to which the tube 5 is connected.

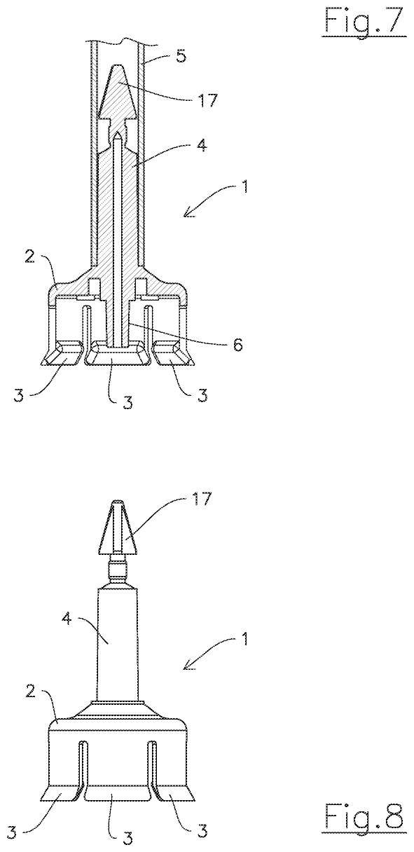

As shown in FIGS. 7 and 8, the hooking and piercing device 1 may provide frangible closing element 17 of the axial hole of the stem 4 at the end of the stem 4 opposite to the one with luer-shaped appendix 6.

In such a case, the path for fluid from the inner space of the vial 7 to the tube 5 is normally closed and may be opened by breaking the frangible element 17 and separating it from the stem 4.

1. A hooking and piercing device for vials and tubes provided with a closing cap openable by pressure, comprising a hood-shaped hood with circumferentially distributed hooking toothed sectors and a connecting part formed by an axially perforated stem which extends axially and centrally out of the hood and is engaged by pressure inside a tube, the axially perforated stem has an axially perforated appendix which extends within the hood, wherein the appendix is shaped like a syringe luer.

2. The device according to claim 1, wherein there is a frangible closing element of on the axially perforated stem which is opposite the end of the axial perforated stem with the luer-shaped appendix.
